(19) United States
(12) Patent Application Publication
(10) Pub. No.: US 2011/0162598 A1
(43) Pub. Date: Jul. 7, 2011

(54) Mass driven motor with a middle signaling piston

(76) Inventor: Craig Richard Smith, Birmingham, AL (US)

(21) Appl. No.: 12/587,568

(22) Filed: Jan. 4, 2010

(51) Int. Cl. F02B 75/18

(52) U.S. Cl. 123/52.1

(57) ABSTRACT

The Mass Driven Motor with a Middle Signaling Piston is an internal combustion, two cycle free flowing piston motor that develops a linear-straight line force by the use of four cylinders and six pistons to accelerate a mass. The force is developed when the mass that lies in the horizontal position is accelerated and stopped and reaccelerated. The force developed is linear-straight line in nature. The force can be harnessed by simple-mere attachment and directed by the positioning of the vertical pistons, in other words-as the horns on a bull, which ever way the horns are pointing, that is the way its going. This allows the user to go in any direction he desires by aligning the vertical piston in that direction.

This application is associated with design patent U.S. 61/062,700 filed Jan. 29, 2008.

### BACKGROUND OF THE INVENTION

1. Field of the Invention

The present invention relates to the conversion of chemical energy to kinetic energy, allowing the kinetic energy to become mechanical energy without any conversion devices except the device itself. It is efficient in creating a linear-straight line force that can be used by mere attachment. The device is also capable of, being an electrical generator if magnets and coils are placed on the vertical cylinders and pistons, thus allowing for an electrical supply readily at hand if needed.

2. The Prior Art

The mechanical force presently is developed by the creation of a rotating-torque Producing crankshaft that requires the earth to push off of in some sort. This crankshaft Requires a device to convert the rotating torque force into a linear force. This is usually Done with a transmission, drive shaft, and rear end. When a reciprocating piston is used to drive a conventional crankshaft internal combustion engine; the piston within the engine are driven linearly by the expansion of exploding gases, which are intern connected by rods to the crankshaft, to produce a rotating power output, which is in turn is connected to the drive shaft that is connected to a rear-end to transfer the force produced to the wheels, allowing the pistons reciprocating motion to push of the earth, thus creating a linear motion from a rotating motion.

This act of having to convert rotating-torque force to a linear force results in inefficiencies and loss of power produced by the pistons. Even though it is done by the combination of devices like transmissions, drive shafts, and rear-ends, all of the methods are responsible-and capable of loosing energy desired for linear motion due to heat-friction.

The arrangement of the mass driven motor with a middle signaling piston is such that there is no need for converters to change the rotating motion of the crankshaft to linear motion. Connecting the combustion pistons to a signaling piston then to another combustion eliminates the need for converters like transmissions, drive shafts, and rear-ends. The arrangement of the combustion pistons in the vertical position in relation to the signaling piston is totally efficient in accomplishing this goal thus allowing the linear motion of the piston to be directly transferred to linear motion for use. The connection of the combustion pistons with the signaling piston with hydraulic fluid creates a free piston assembly. The middle-signaling piston allows for the timing of the device to ensure the devices' fuel is injected into the cylinder to allow for a timed detonation. The middle signaling piston is directly connected hydraulically to the combustion pistons and functions as if connected by steel but is much more efficient in its role. The hydraulic fluid allows for the movement of parts in the device without the wear and tear that is associated with metal and its inefficiencies. In order for a combustion engine to be efficient, the control of the degree of the compression (that is the compression ratio) is critical, and the high compression ratio of efficient combustion processes result in the need to take and stop the combustion pistons very near (often within 1 millimeter) the opposite end of the combustion chamber (usually the engine head). The opposite challenge is achieved simultaneously as the timing in the TDC is done because of the middle signaling piston aspect of the engine allows for BDC to happen for the opposite combusting piston.

The power from a two-stroke free piston motor can vary with force and friction especially when the motor is and cool and first started, as with all motors until warmed up. The difficulty with prior art free piston-two stroke engines and the stoppage at the TDC and BDC is common in almost all engines and are the critical points of functionality. The over coming of these obstacles is part of the creation of a process that will allow the invention of new and different devices in the future. This new type of motor with a middle signaling piston eliminates all of the previous problems associated with a free piston engine, as you will see as you progress through this simple but technical material of the Mass Driven Motor with a Middle Signaling Piston.

The Society of Automotive Engineers (SAE) have produced much informative material on the various free-piston engines of prior art. A few of these are U.S. Pat. No. 5,363,651 and U.S. Pat. No. 6,152,091 which may be relevant to the processes of free piston engine. It must be noted that most of the prior art involves the free piston

Mass Driven Motor with a Middle Signaling Piston engine combined in conjunction with a hydraulic pump of some type. The patents that might also have relevance also are as follows:
U.S. Pat. No. 4,369,021 Henitz: Free-Piston Engine Pump.

### BRIEF DESCRIPTION OF THE DRAWINGS

FIG. 1 is a Plan View of the motor displaying the placement of the Air Inlet and Air Outlet Valves with the Glow Plug and the Fuel Injectors correct position also the Middle Signaling piston at approx. detonation position. Also the correct position for the Air Inlet Port and Air Outlet Port.

FIG. 2 is an Elevation View showing the Air Outlet Ports and Air Inlet Ports' the Pick-Up Coil with the correct placement of the Variable Resistor Switch and the Wires going to the Injectors and the Diodes and Bleeder Resistors to direct the Current being generated by Middle Signaling Piston and the Pick-Up Coil also FIG. 2 also displays the Alignment Bolt with Lock Washer, Seal and the Jam Nut.

FIG. 3 is and Elevation View and also a mirror Image of FIG. 2

FIG. 4 and FIG. 5 are Elevation Views of the end of the Motor showing one piston at detonation and the other at intake position also the different placements of the Compression and Hydraulic Rings.

FIG. 6 is a Plan View displaying the placement of the Fuel Injectors the Air Inlet Valve, Air Outlet Valve Air Inlet Port and Air Outlet Port also the Setup/Start up Coil with Cover the Pick-Up Coil and the Oil Fill Port all in relation to the Vertical Cylinders.

FIG. 7 is an Elevation View depicting placement of Fuel Injector in the middle of the Head with the Signaling Injector Wire attached to (correctly aligned)

FIG. 8 is an Elevation View and is a mirror image of FIG. 7

Diode leading to Variable Resistor Switch that is connected to the Pick-Up Coil. The Middle Signaling Piston is also depicted along with the Setup/Startup Coil Pack. The Oil Fill Port is also depicted in the Vertical Cylinders.

FIG. 9 is a Section View showing the Fuel Injector With the injector wire wired to a correctly aligned Diode that leads to the variable Resistor Switch then the Pick-Up Coil also with the other polarized wire leading to Diode, Bleeder Resistor and End wire to Battery also drawing shows Vertical Piston with the correct placement of compression Rings and Hydraulic Rings and the Setup/Startup Coil Pack.

FIG. 10 is a Sectional Drawing depicting the alignment of the two halves of the Motor, the numbering of the Vertical Pistons along with the correct position of the Middle Signaling Pistons when they are traveling in opposite direction also the magnet that travels with the Middle Signaling Piston and the Setup/Startup Coil Pack and Cover.

FIG. 11 FIG. 12 FIG. 13 is a Detail Drawing of the Vertical Cylinders and shows the difference in the two types needed.

FIG. 12 without the Setup/Startup Coil and

FIG. 13 with the Setup/Startup Coil.

FIG. 14 is a Plan View of the Horizontal Cylinder Section.

FIG. 15 is a Plan View of Short Horizontal Cylinder Section.

FIG. 16 is a Plan View of the Heads (caps)

FIG. 17 is a Plan View of a Vertical Piston showing the placement of the Hydraulic Rings and the Compression Rings.

FIG. 18 is a Plan View of the Middle Signaling Piston with the Magnet, Separator Ring and Locking Pin

FIG. 19 FIG. 18 is a Plan View of the Oil (hydraulic) Rings

FIG. 20 is a Plan View of the Compression Rings

FIG. 21 is a Plan View of the Magnets Rings

FIG. 22 is a Plan View of the Spacer Rings

FIG. 23 is a Plan View of the S/S Coil Guards

FIG. 24 is a Plan View of the Intake Manifold

FIG. 25 is a Plan View of the Exhaust Manifold

FIG. 26 is a Plan View of the Fuel Injectors

FIG. 27 is a Plan View of the Glow Plugs

FIG. 28 is a Plan View of the Locking Pins

FIG. 29 is a Plan View of the Locking Shafts

FIG. 30 is an Elevation View depicting the Preferred Embodiment

FIG. 31 is an Elevation View depicting the Motor with both the Intake and Exhaust Manifolds in position also the Motor at time of Detonation.

FIG. 32 is a Plan View showing Magnet Position post Ignition also relative position of Air Flow Meter.

FIG. 33 is a Detail Drawing of Air Flow Meter (off the shelf Tech)

FIG. 34 is a Detail Drawing of Setup/Startup Switch (off the shelf Tech)

FIG. 35 is a Detail Drawing of Framing Bolts (off the shelf Tech)

FIG. 36 is a Detail Drawing of Cap Bolt with Lock Washers (off the shelf Tech)

FIG. 37 is a Detail Drawing of Guard Bolts for bolting on Coil Guard (off the shelf Tech)

FIG. 38 is a Detail Drawing of Alignment Bolt with Jam Nut and Seal (off the shelf Tech)

FIG. 39 is a Detail Drawing of Electric Fuel Pump (off the shelf Tech)

FIG. 40 is a Detail Drawing of Bleeder Resistor (off the shelf Tech)

FIG. 41 is a Detail Drawing of O2 Sensor (off the shelf Tech)

FIG. 42 is a Detail Drawing of Co2 Sensor (off the shelf Tech)

FIG. 43 is a Detail Drawing of One Shot (off the shelf Tech)

FIG. 44 is a Detail Drawing of Fuel Pressure Regulator (off the shelf Tech)

FIG. 45 is a Detail Drawing of Air Filter (off the shelf Tech)

FIG. 46 is a Detail Drawing of Air Inlet/Outlet Valve (off the shelf Tech)

FIG. 47 is a Schematic Drawing of Electrical System in Run Position

FIG. 48 is a Schematic Drawing of Electrical System in the Setup Position

FIG. 49 is a Schematic Drawing of the Electrical System in the Startup Position

FIG. 50 is an Elevation Drawing depicting the Electrical system on the Motor

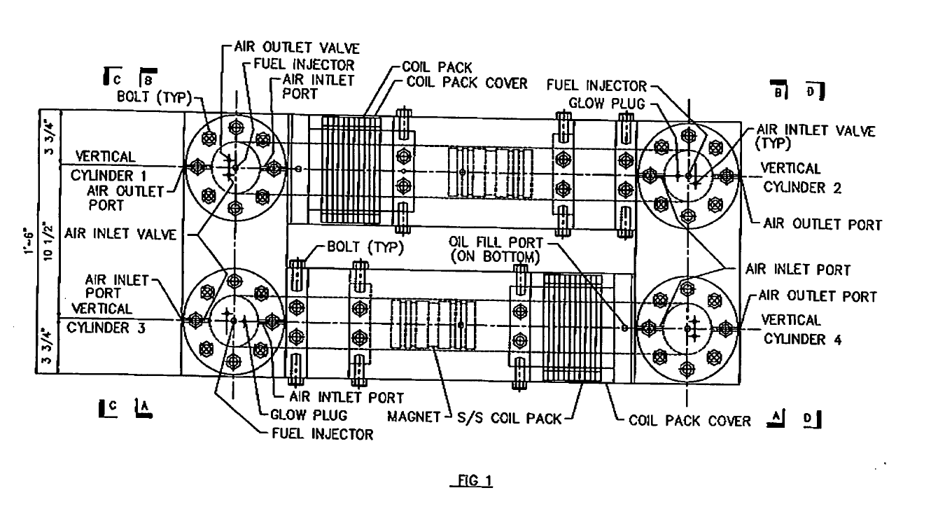

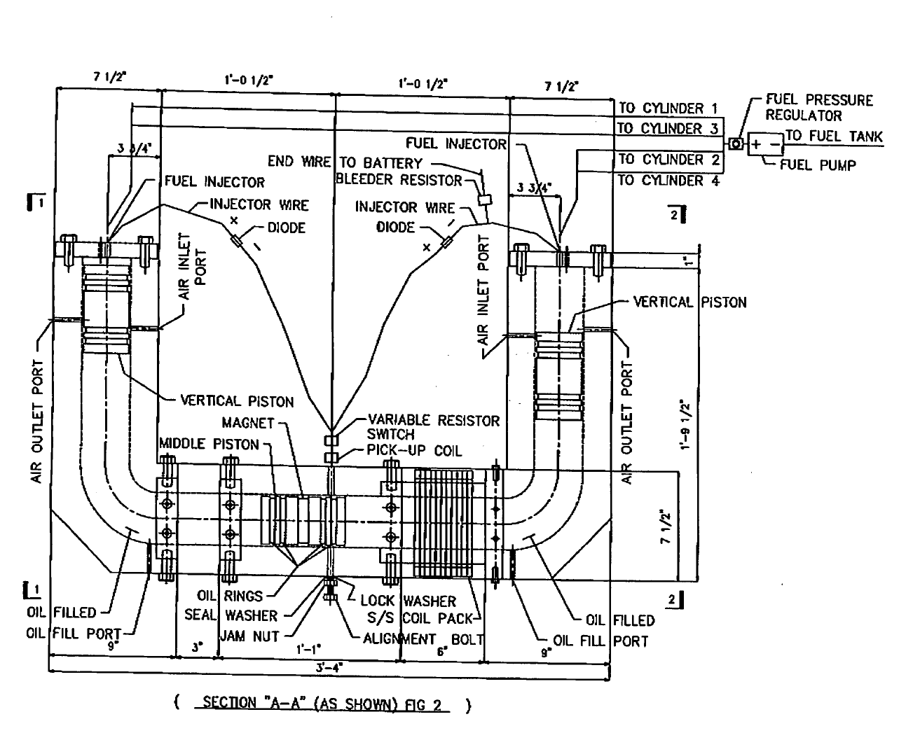

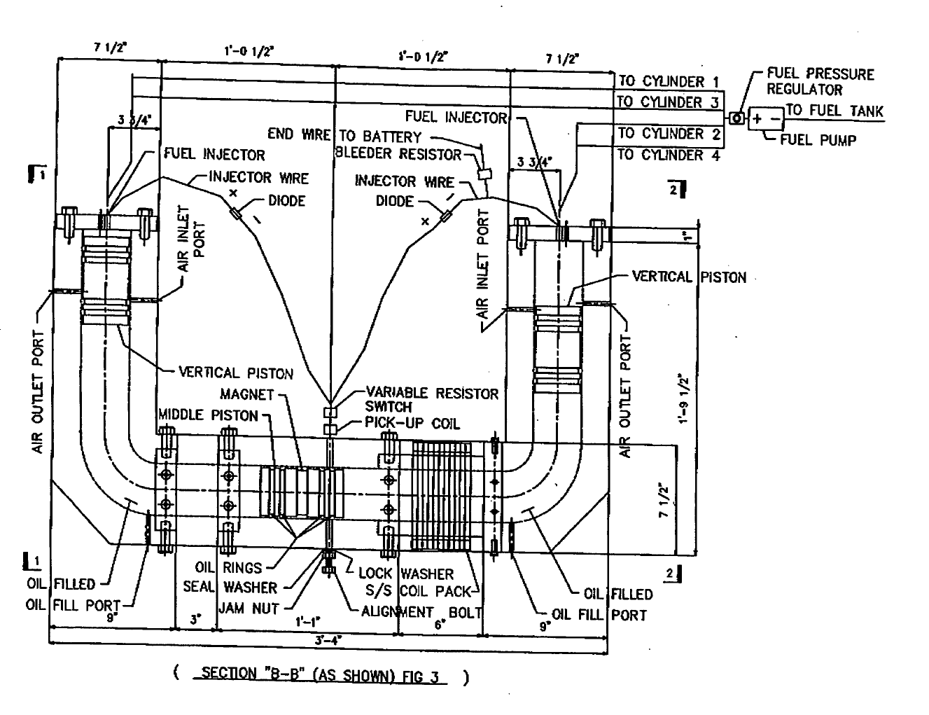

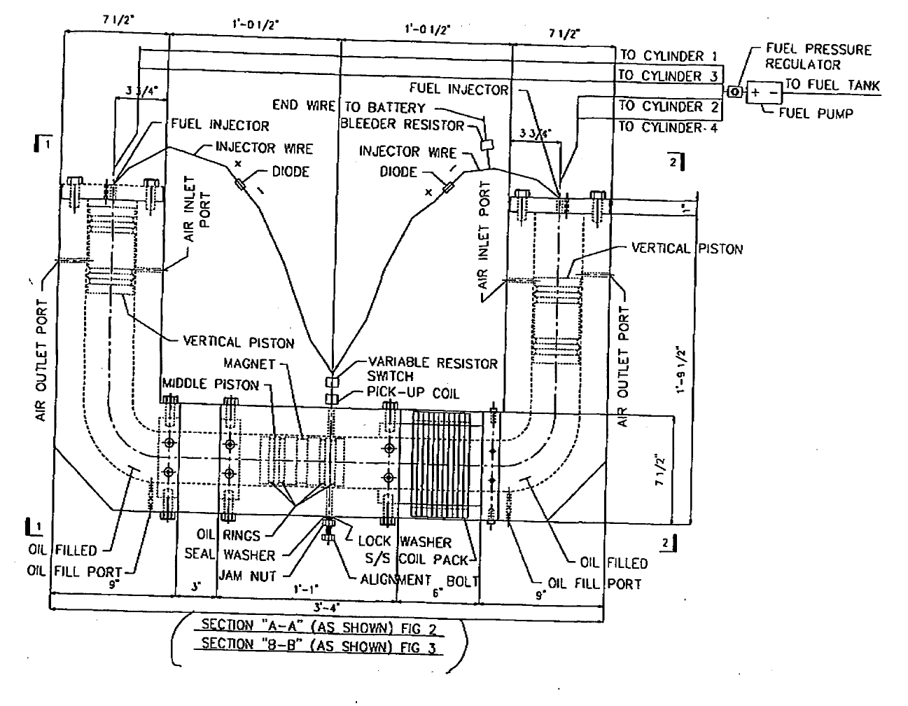

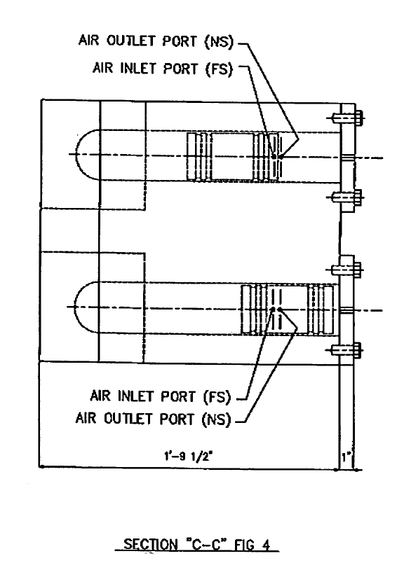

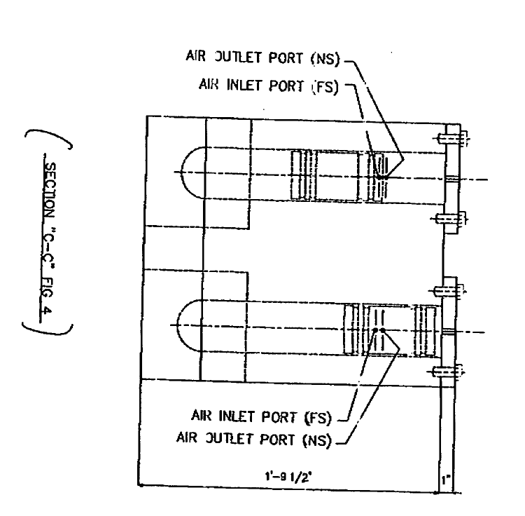

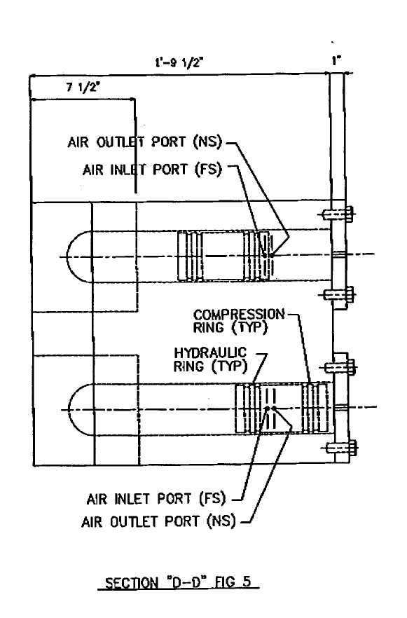

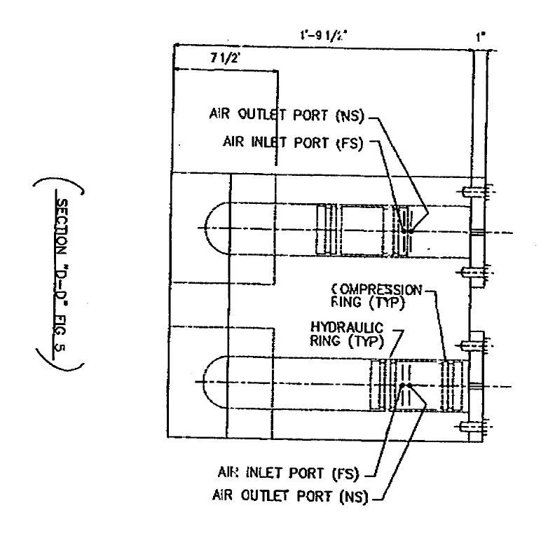

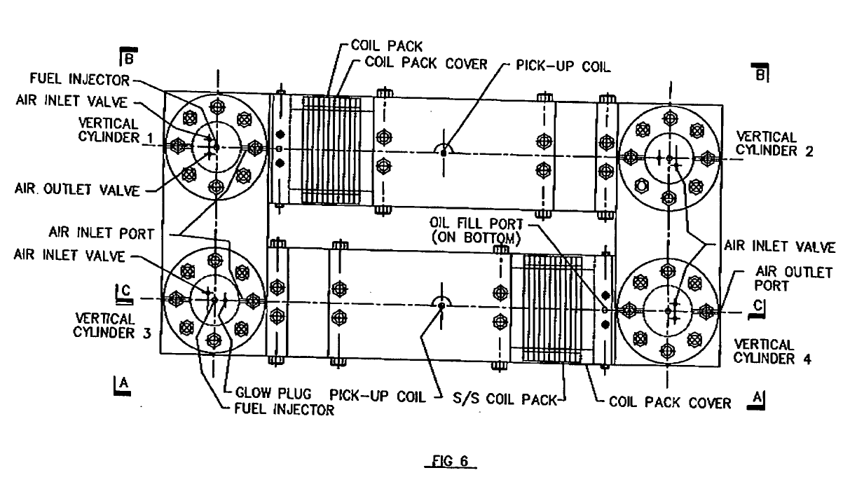

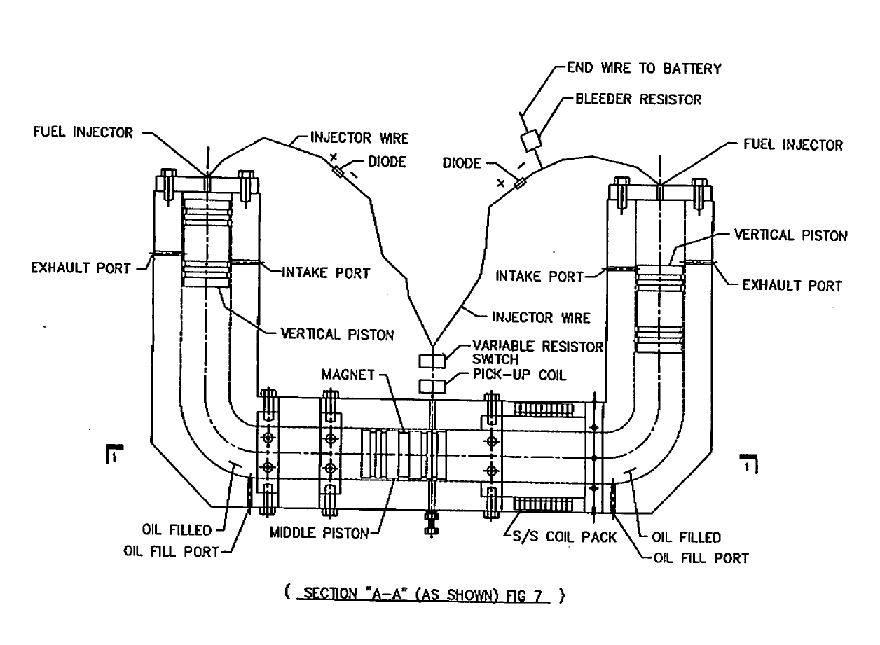

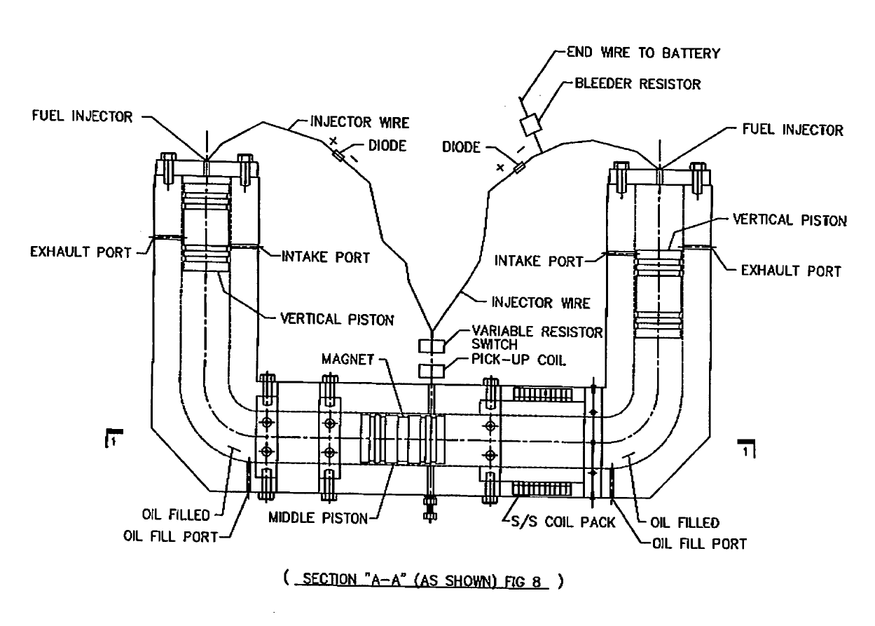

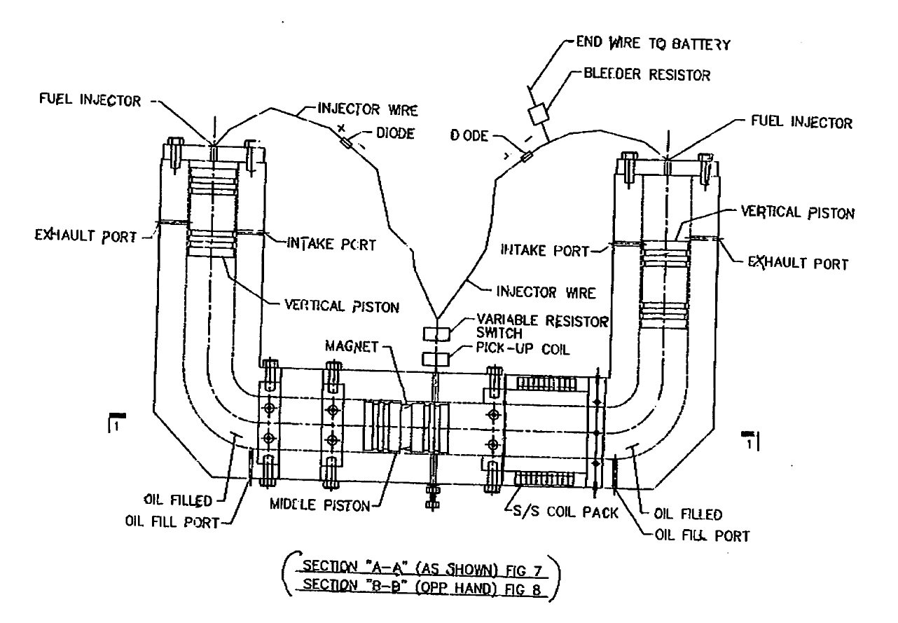

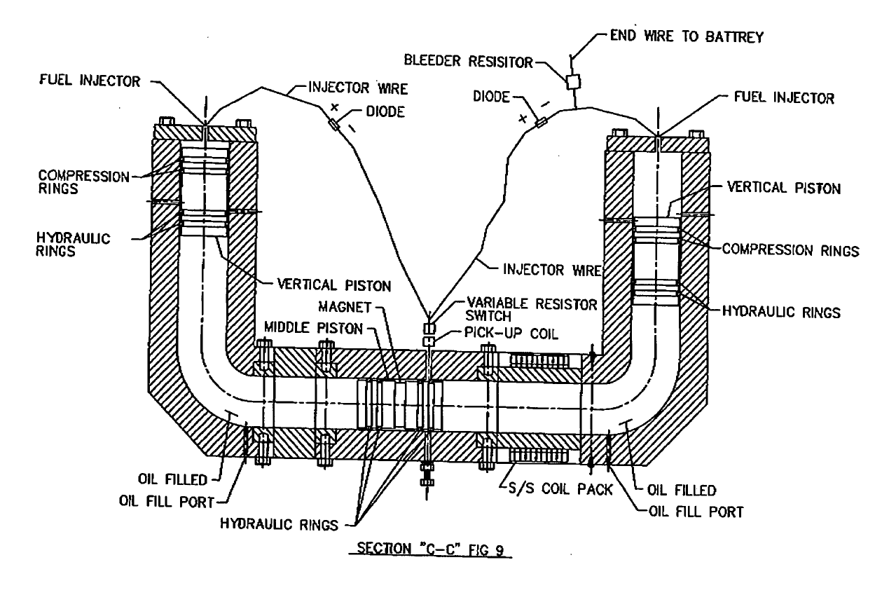

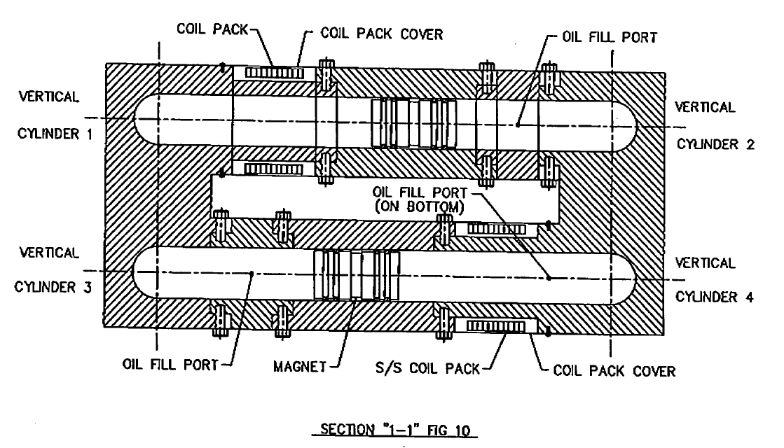

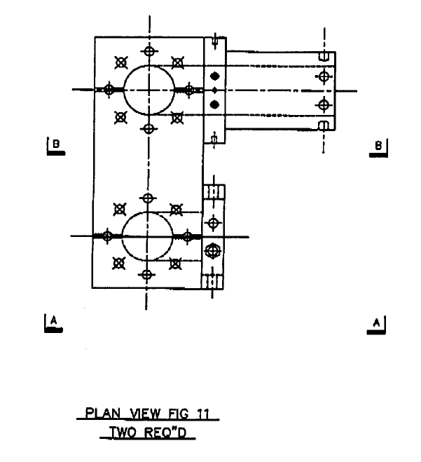

### THE PREFERRED EMBODIMENT

The drawing is an Elevation view of a two-cycle motor that uses the acceleration of mass to develop a linear force. The extended or elongated “U” shape and the use of hydraulic fluid to transfer forces developed within is what allows this device to achieve what other motors-engines have had trouble doing, developing a linear force and then transferring this linear force to work without converters or adapters. No prior art has achieved this as efficiently as the (MDMMSP) Mass Driven Motor with a Middle Signaling Piston.

The drawing depicts a motor in the start position but if in this position at time of starting (i.e. motor is stopped) then a situation exist where if there is going to be any movement from 40 the vertical piston 32 hydraulic fluid 43 middle signaling piston 32B hydraulic fluid and 9 vertical piston there has to be a method of eliminating the vacuum locks that exist. between the 6, 7 cylinder heads and the 9, 40 vertical pistons. The use of 5, 45 air inlet valves and 44-air outlet valve all of which are controlled by the 28 setup/startup switch do this. Both 44 air inlet valve and 45 air outlet valve open to let air flow when the setup function of 28 setup/startup switch is activated with the 16 setup/start coil pack moving 40 vertical piston downward away from 6 cylinder head 32 hydraulic fluid with 43 middle signaling piston 32B and 9 vertical piston all placed into setup/start position. Then the 28 setup/startup is switched to the startup position. This action changes the direction of current in the 16 setup/startup coil and opens the 45 air inlet valve. The Mass Driven Motor with a Middle Signaling Piston 28-setup function of the setup/startup switch induces a low amperage charge on the 16-setup/startup coils. The same 16 switch in the startup position is connected to a 23 One Shot electrical device where the function of the 5, air valve is terminated upon ignition.

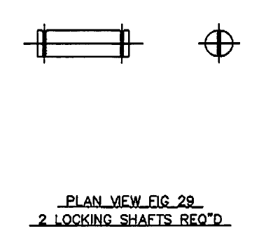

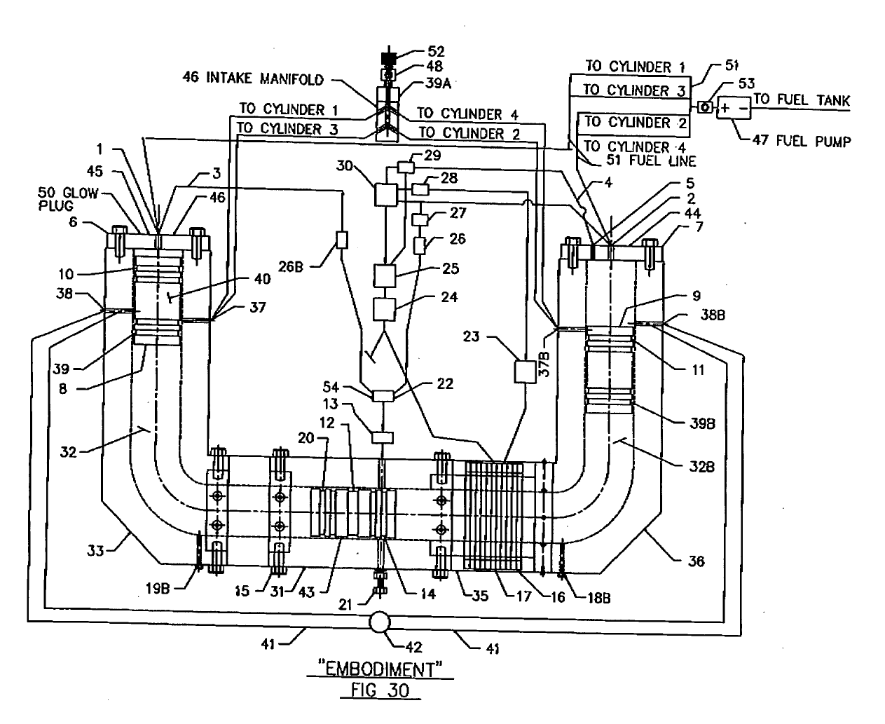

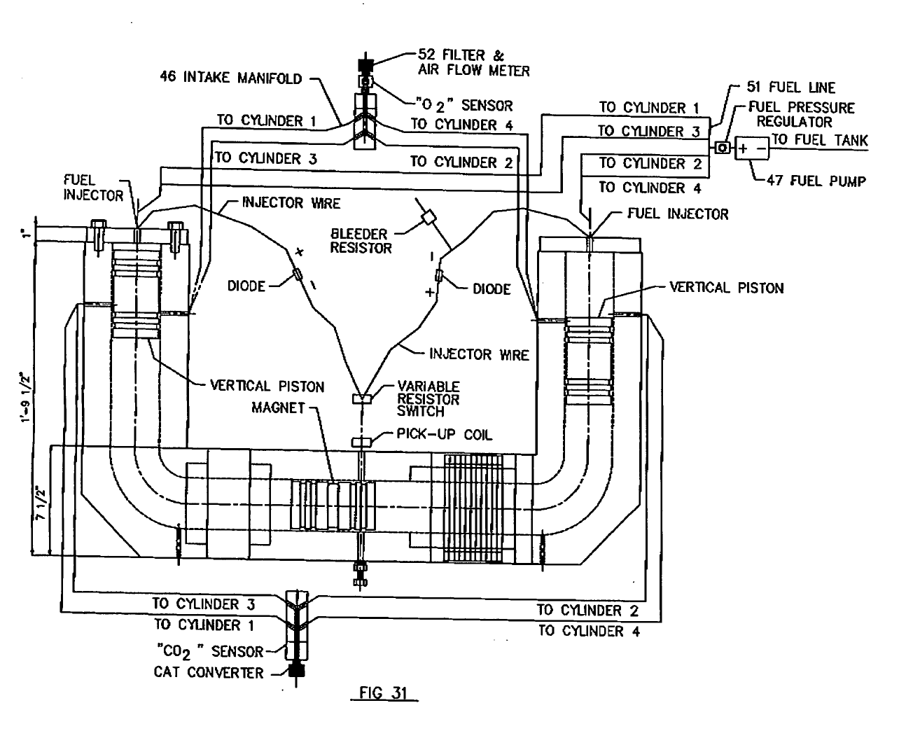

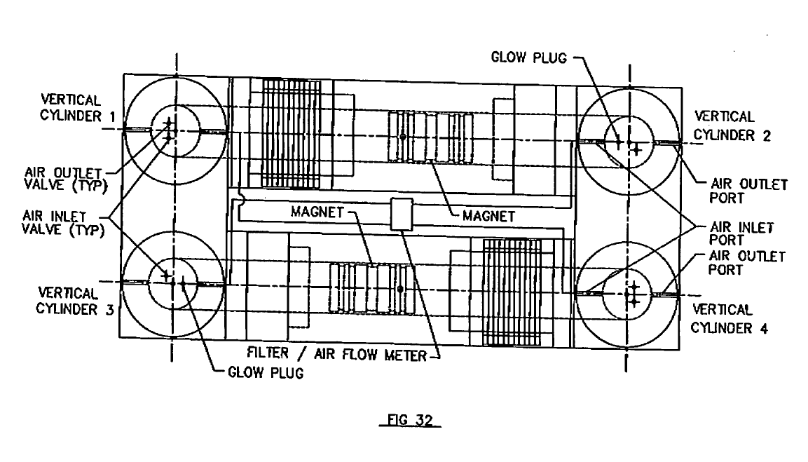

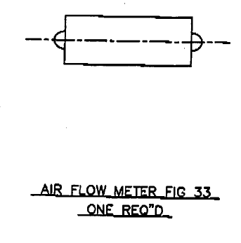

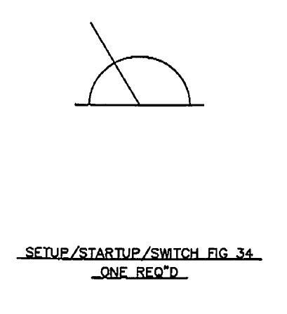

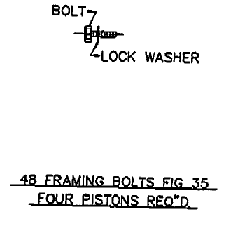

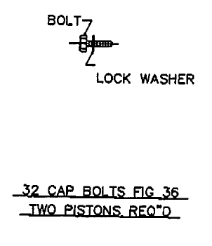

The Embodiment displays 40 a piston at near detonation with 33 the vertical cylinder that connected to 43 the horizontal piston by 32 the hydraulic fluid. The 43 horizontal piston is connected to 9 opposite vertical piston by 32B the hydraulic fluid controlling 9 the vertical piston. The drawing displays the 9 vertical piston-nearing end of down stroke. The force of the mass in the 33 & 36 are equal. The amount of force from the acceleration and deceleration of 43 the horizontal piston is where the FIG. 30 MDMMSP gets its linear force. The 43 middle signaling piston is oscillating from 33 vertical cylinder to 36 vertical cylinder developing a force. This oscillating force is transferred to 6 cylinder head and 7 cylinder head. The cylinder heads are attached to the 33 and 36 respectively. The 43 middle signaling piston oscillates past 13 the pickup coil. The pickup coil sends an accurately timed injection signal to the 1, 4 injectors. The pickups signals flow through 22 a variable resistor switch that allows for the controlling of the speed of the motor. Then through 26 and 268 diodes which by alignment allow for direction of current to correct injector-also for bleeding off of current by 27 bleeder resistor which allows the recharging of the 30 the battery which is used for the activation of glow plugs at pre start also for the 25 capacitor bank that gives the 16 setup/starter coil enough amperage to accelerate content of all cylinders to point of detonation.

The starting of the MDMMSP is accomplished by the solenoid effect of 16 s/s (setup/startup) coil and the 43 middle signaling piston. The action from the solenoid effect is transferred from the 43 middle-signaling piston to both 32 and 32B to 40 and 9 respective. This moves 40 vertical piston to the point of detonation and 9 vertical piston pass 38B the exhaust port and pass 37B intake port. The fuel is injected in to top of 33 the vertical cylinder between the 6 cylinder head and 40 the vertical piston. The action simultaneously causes 9 vertical piston to pass 38B, 37B air outlet and air inlet ports respectively. The action also causes 43 middle signaling piston to pass 13 pickup coil. The pickup coil is activated by a 12 signaling magnet. This signal is controlled by a 22 variable resistor switch that is connected to 26, 26B diodes that control activation 4, 1 injectors at the correct time needed which are feed by the fuel pump. The current is bled off with a 27-bleeder resistor to charge 30 the battery and the 25-capacitor bank. All 46, 25, 30, 28, starting and controlling devices are routed through 29 the fuse box. Upon detonation of the engine the action becomes a chain reaction. Note should be taken that simultaneously the inverse mirror image of all the above is also accelerating and decelerating and re-accelerating in the opposite direction thus eliminating any development of torque and increasing the total amount of force ×2 The 38B, and 38 exhaust ports are connected to 41, and 41B the exhaust manifold with 42, Co2 sensor. The 37, 37B intake ports are connected to 46-intake manifold is connected to a 48-air flow meter and that is topped with an air filter. This completes the setup/startup of the engine and its function next is the assembly of the same per embodiment. It must be noted that before general assembly there must be some pre-assembly of interior parts and exterior part.

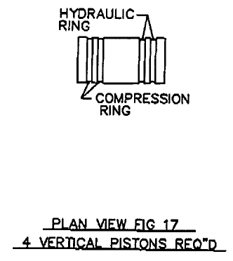

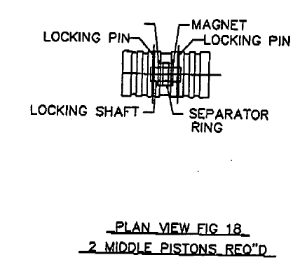

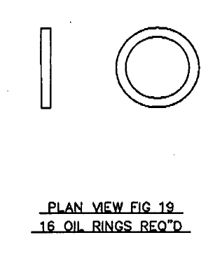

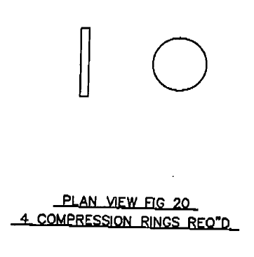

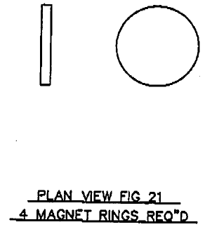

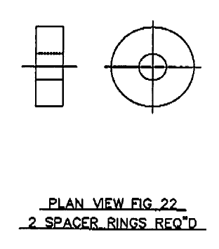

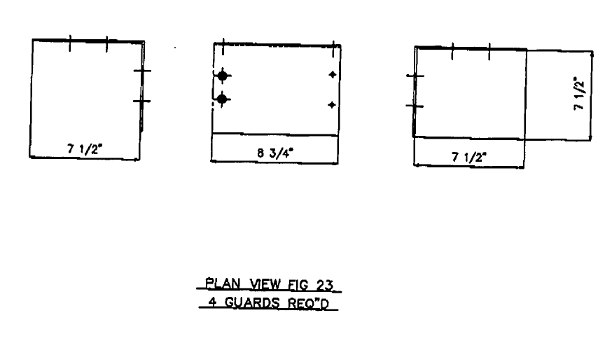

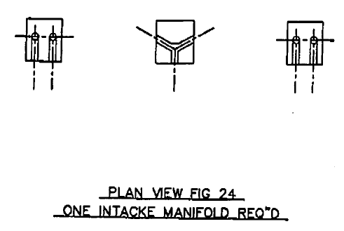

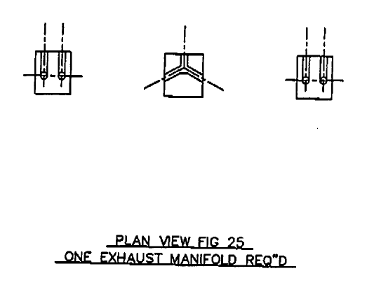

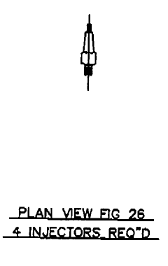

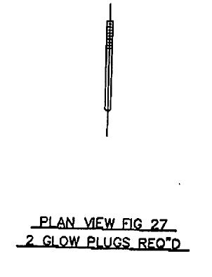

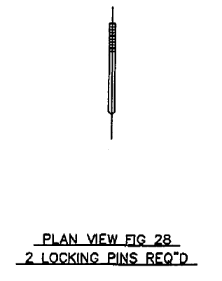

Assembly of the 40, 9 vertical pistons starts with the installation of FIG. 20 compression rings on one end and on the opposite end install FIG. 19 oil rings. Secondly assembly of 43 middle signaling piston is done by first placing a FIG. 21 magnet then steel spacer then 21 magnet together in a +-space +-orientation on locking shaft of middle piston then inserting locking pins-next install FIG. 19 oil rings on both ends of the piston.

This concludes the pre-assembly of internal parts to enable general assembly. Next the assembly of the air flow meter and the O2 gauge. Insert the oxygen sensor in the top-front of the air flow meter.

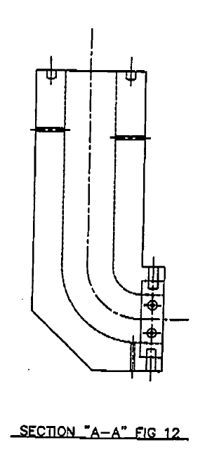

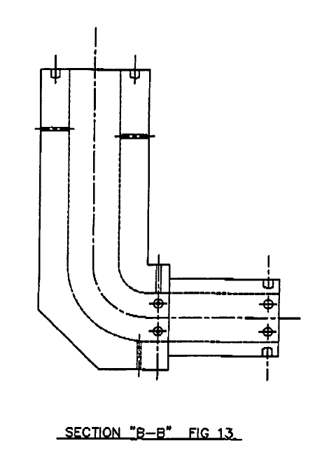

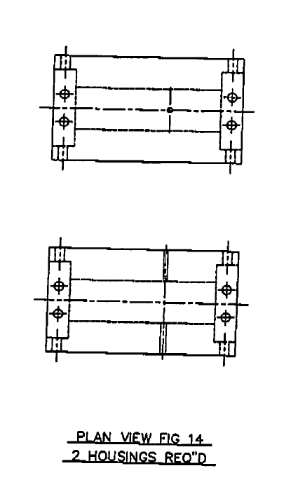

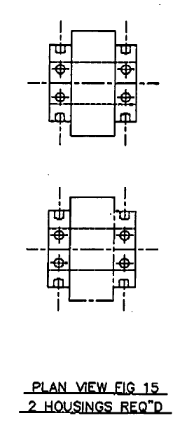

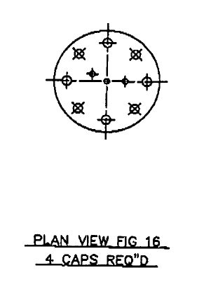

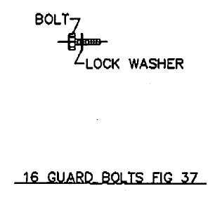

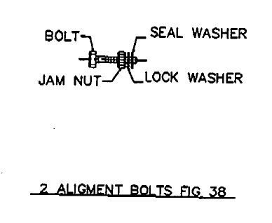

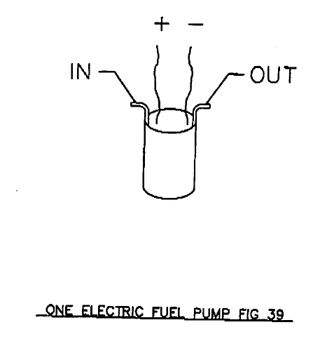

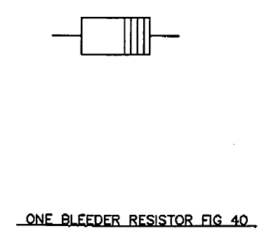

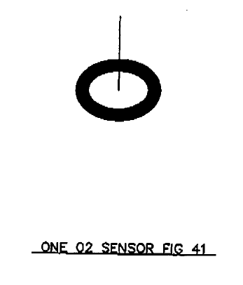

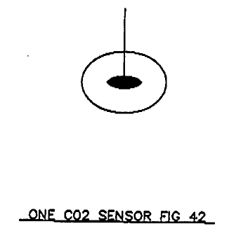

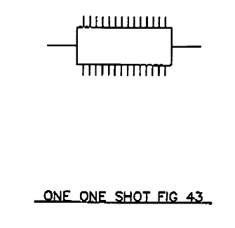

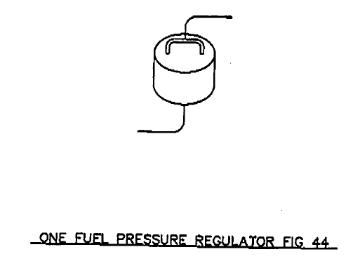

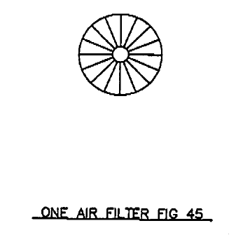

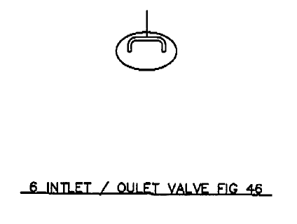

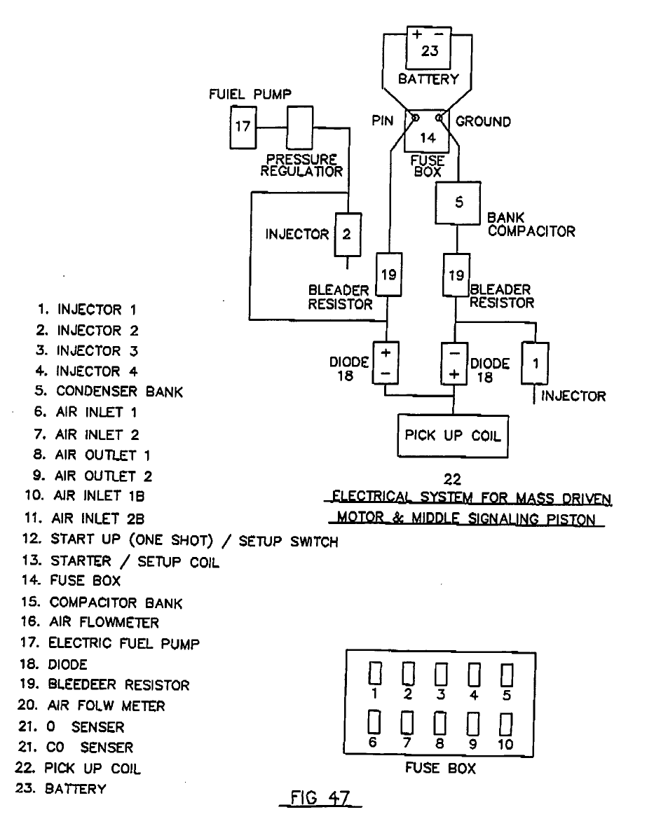

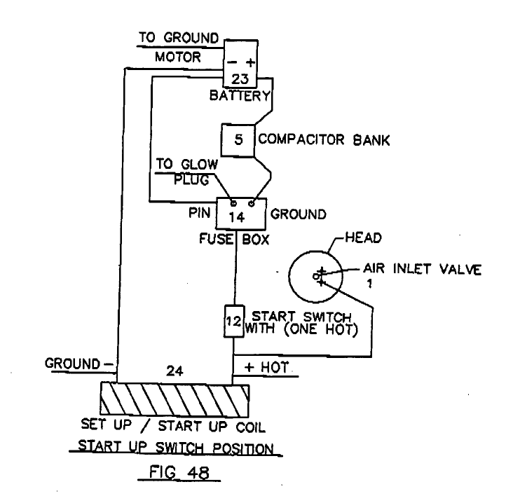

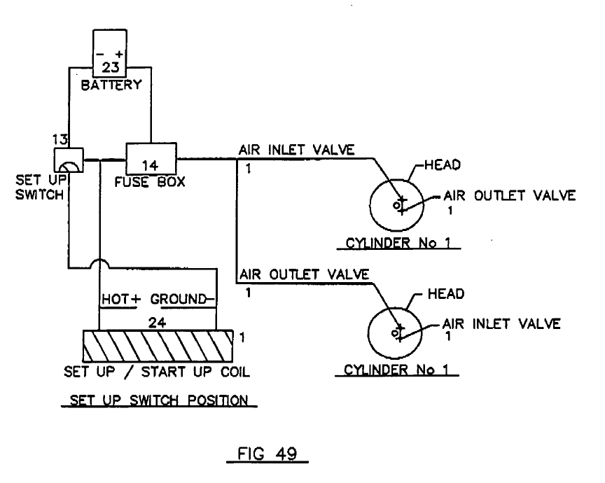

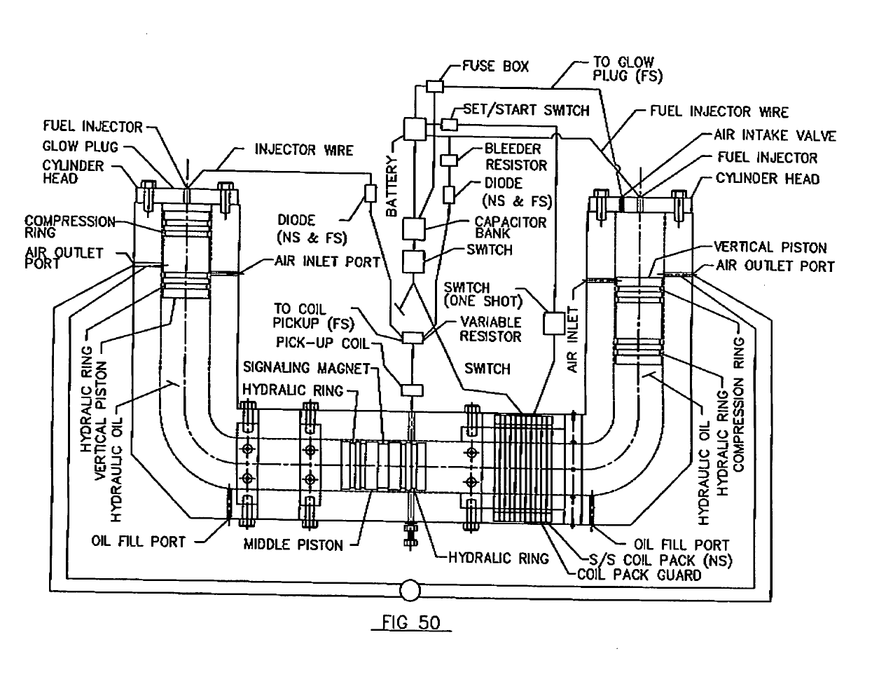

General Assembly is started by inserting pre-assembled 43 middle signaling piston into 35-FIG. 14 housing and secure with 21-FIG. 38 bolt, jam nut, lock washer, seal washer next install 16 s/s coil on to same housing. Then bolt 35 housing to 36 vertical cylinder. Then bolt 31 housing to the opposite of 35 housing then to the free end of 31 housing bolt on 33 opposite vertical cylinder. Take out 18, 19 the oil fill bolts to allow for air escape when inserting 40, 9 vertical piston into 33, 36 vertical cylinders. Insert 40, 9 vertical pistons and temporally install 2″ spacers in open end of vertical cylinders. Invert the engine pour hydraulic fluid in both 19, 18 oil fill ports. Install bolts to seal the same. Remove 21 middle alignment screw and pour in more hydraulic fluid (note: get all air out of this part of the engine) then reinstall 21 bolt with jam nut lock washer and seal washer making sure jam nut prevents the bolt from interfering with 43 middle signaling piston. Turn the engine up right and install 6, 7 the cylinder heads. Install on 6 cylinder head 1 fuel injector, 45 air inlet valve, and 50 glow plug. Then on 7 cylinder head install 44 air outlet valve 5 air inlet valve 2 fuel injector. Now install 17 the coil pack guard. Repeat this whole assembly once again and turn it around one hundred and eighty degree attach both halves of the motor together and install both the 46 intake manifold and the 41 exhaust manifold. Then install the electrical system per the drawings on sheets fourteen and fifteen. Note: both the electrical wires on both 13 Pick-ups Coils should be connected together then connected to one 22 Variable Resistor Switch.

### Assembly of Mass Drive Motor with a Middle Signaling Piston

The first part to assemble is item “B” with item “G” slide Item “G” into item “B” and center to alignment screw. This should be done twice since the total motor is comprised of a side and an inverse mirror side. Secondly attach item “C” to item “B” do this to both assemblies. Thirdly insert pistons (items “F”) into sections “A-A” and sections “B-B”—two of each. Forth—attach assembled items “B” and “C” to sections “A-A”. Fifth—slide starter coil on section “B-B”. Sixth—attach assembled parts section “A-A” items “B” and “C” to section “B-B”. Seventh step is to set a gap of −2″ from ends of piston in sections “A-A” and section “B-B” after pistons are set put the heads (item “D”) on sections “A-A” and section “B-B”. Eighth—is to install pick up coils into items “B” times 2. Ninth—is the installation of air inlet valves (Nos. 6,7 on dwg. 14) to all four heads—item “D”. Tenth—install air outlet (No. 8 9 on dwg. 14) to heads (item “D”) closest to starter coil. Eleventh—Install Glow plugs (Item “P” dwg. 9) into heads that sit atop of sections “A-A”. Twelfth—is attaching the intake manifold—(item “Q”) to sections “A-A” and “B-B”. Note: Item “J” sets in the middle of sections “A-A” and “B-B”. Thirteenth—is the attachment of the exhaust manifold—Items “R”—to sections “A-A” and “B-B”. Note: Items “R” sets outside of sections “A”-A” and sections “B-B”. Fourteenth—is the installation of the hydraulic fluid into the oil fill holes located in the bend of sections “A-A” and “B-B”. The hydraulic fluid should be filled till all air is removed from
enclosure—between the pistons. Note: the pistons sitting in sections “A-A” and “B-B” should be 2″ from their heads. Fifteenth—is removing screw in the middle of items “B” and fill hole with hydraulic fluid replace the screw and then tighten the lock nut to prevent the bolt from moving. Note: when replacing screw in hole check to insure that screw will not obstruct oscillating pistons path—then tighten lock nut. Sixteenth—step of the main body of the motor is the installation of the heads (item “D”) place item “D” on the sections “B-B” and sections “A-A”. Seventeenth—install (item “N” dwg. 9) guard around the startup/setup coil to protect it.

This concludes the assembly of the main body of the motor; the electrical assembly is next.

The Electrical Assembly for the Mass Driven Motor with a Middle Signaling Piston

The electrical assembly of the Mass Driven Motor with a Middle Signaling Piston is given in drawings on drawing sheets 14,15. The setup drawing displays the way the air inlet and air outlet valves work when the starter/setup coil is in the setup-wiring configuration.

The drawing of when the starter/setup coil is in the startup wiring configuration is demonstrating the activation of the air inlet valve at the time the start switch is activated. The start switch should be powered from the capacitor bank and fused at the fuse box. The glow plug is in place to ensure a higher degree of certainty of detonation at the time of starting and is only placed and wired on the side of the motor where initial detonation is initiated. The fuse box should act as the point to activate all other electrical functions on the motor.

The Electrical System for the Mass Driven Motor & Middle Signaling Piston drawing demonstrates the method of controlling the flow of electricity in the system with the diodes and the bleeder resistors. The pickup coil will pick a +signal in one direction and a −signal in the opposite direction. The diodes allow for the current flow to the correct injector at the correct time. The bleeder resistors allow the recharging of the capacitor bank and the recharging of the battery when motor is in the run mode. The Setup/Startup Mass Driven Motor with a Middle Signaling Piston:

Switch allows the user to “setup” the motor for starting in one direction and to “startup” in the other direction

### Overview

The force developed in the device is achieved by the acceleration of the piston in the Middle and the hydraulic fluids that accompany it. The force is developed initially when the piston on either end is accelerated by the use of a solenoid technique. The pistons in the device are made of aluminum and the walls of the device are made of a non-ferrous metal (material) with a coil of wire secured off center of the middle path of the middle piston. This allows the piston in the middle to be accelerated by the induction of electric current into the coils (by a capacitor bank) located to the right and to the let of the center of the dead center of the middle pathway the middle piston travels.

Note: I use the terms right and left conjointly because of the design of the total device—where one side of the device is and inverse mirror image of the other and works simultaneously and opposite in direction to the other half.

The total device is made of a minimum of six pistons—one piston on each end of a elongated double “U” shape where the design of a two stroke engine lie i.e.: a “head”-a “piston”—vertical in position relative to middle piston—and down on the sleeve are a series of openings the one closest to the top-nearest to the head is used as an “exhaust port” and the one below the exhaust port is the “intake port”. This allows a two-stroke engine setup to exist. The vertical piston is long enough to allow for the combustion to take place in the upper part of the engine and still maintain a hydraulic seal below the Intake and exhaust port. The area below the piston is filled with hydraulic oil to the middle piston. The middle pistons serve three purposed, first the middle pistons increase the amount of mass that is located in the middle of the elongated” shapes which is the More like 1 ______ 1 (mirrored) without the opening at the end of the horizontal line.

The second purpose for the middle pistons is to enable timing magnets for correct injection timing of diesel fuels. Thirdly the middle pistons Allow coils to be placed off center for starting. The six pistons in the elongated “U”s are accelerated in opposite directions. Placed in dead center of the horizontal portion of the elongated “U”s on the pipe the pistons are traveling thru are pickups with coils that are insulated front the rest of the pipes. This insulating allows a +plus and a −minus voltage to occur depending on the direction the middle piston is traveling at any given moment in time. This is very important aspect of the motor. Hydraulic oil fills the area of the other ends of the middle pistons to the bottom of the hydraulic seal of the opposing vertical pistons—thus pushing the top of the piston up pass both intake and exhaust ports allowing the force developed from the detonation of the first vertical pistons to first apply forces on the heads atop of the cylinders of the first vertical pistons while simultaneously accelerating the hydraulic fluids. The middle pistons pass the pickup coils. The hydraulic fluids with the pistons and send vertical pistons to the points of detonation. This mass acceleration creates tremendous amounts of force—that has to be stopped and reaccelerated in the opposite directions. This creates a force on the head of the second vertical pistons.

Note: without a counter action happening simultaneously the device would create torque. Therefore the inverse mirror image device is used to first eliminate a torque problem and secondly and increase in total forces developed from the device as a hole. The forces are used when the device is connected to an object—whichever direction the vertical pistons are pointing will be the direction the force will be directed.
Note: It must be noted since a voltage is developed and is partially discharged to the injectors and capacitor banks thus allowing both the middle pistons too move in opposite directions and go positive “+” at the same time and then go negative “−” at the same time to prevent a neutralizing effect from occurring when the middle piston pickup coils discharge current and to create an injection signal in the inverse mirror vertical pistons. Note: The pistons in move only approximately four inches in any one direction.
Note also: The change of the speed of the middle pistons changes the amount of voltages developed at any one time. There fore by using injectors that are controlled by the voltages (i.e. the greater the voltage the longer the injectors injects) thus self-adjusting the amounts of fuels at any time for stopping and acceleration (movement) of the middle pistons and opposite vertical pistons.

### SUMMARY OF THE INVENTION

The objective of the present invention is to produce an efficient motor that produces linear force without additional converters like transmission, pumps and gearboxes. Yet another objective of present art is to do this well with a two stroke free piston setup that allows for the user to direct the force developed in any direction to achieve ones goal.

The present art accomplishes this objective without converters or other devices to allow the linear motion of the piston to become linear force available for work.

The Mass Driven Motor with a Middle Signaling Piston has only six moving parts in the motor and accomplishes by the acceleration-deceleration of mass the desired objective previously mentioned. Using the “form and function” association—the four vertical pistons upon detonation develop a linear force in the pistons. This linear force is transferred to the cylinder heads that in turn is transferred to the body of the motor thus the point of relativity where the force is developed travels with the motor. Since the point of relativity travels with the motor using the earth to push off of is not needed. This motor pushes off inside its self. This allows the user to direct the force in any direction desired thus the motor can be used in a very large array of vehicles without adapters to allow for conversion of torque force to linear force. The only thing the user needs to do is have a good method to attach the motor and vehicle together.

1. The Mass Driven Motor with a Middle Signaling Piston will develop a linear-straight line force using four cylinders and six pistons to accelerate a mass-stop that mass and reaccelerate it again. This force can be transferred by simple attachment of the Motor without use of Adapters or Converters to convert the linear force developed inside of the Motor. This force can be directed by alignment of the vertical pistons in a table setup or bearing setup or both.
